(19) United States
(12) Patent Application Publication
(10) Pub. No.: US 2015/0278229 A1
(43) Pub. Date: Oct. 1, 2015

(54) APPARATUS AND METHOD FOR PRESENTING AND ANALYZING ENVIRONMENTAL DATA

(71) Applicant: ZOETIC DATA, INC., San Francisco, CA (US)

(72) Inventor: Rebecca E. Skinner, San Francisco, CA (US)

(73) Assignee: ZOETIC DATA, INC., San Francisco, CA (US)

(21) Appl. No.: 14/667,366

(22) Filed: Mar. 24, 2015

Related U.S. Application Data
(60) Provisional application No. 61/970,187, filed on Mar. 25, 2014.

(51) Int. Cl. G06F 17/30; G06F 17/50

(52) U.S. Cl. CPC G06F 17/30061; G06F 17/30554; G06F 17/30241; G06F 17/5009

(57) ABSTRACT

In one aspect, a method of managing environmental data associated with a geographic location includes: (a) obtaining geographical data of the geographic location; (b) obtaining meteorological data of the geographic location; (c) obtaining biological data of the geographic location; (d) cross-linking the geographical data, the meteorological data, and the biological data of the geographic location; and (5) presenting the cross-linked data for the geographic location in a graphic format. In one aspect, a method of environmental analysis includes (a) acquiring biological data of a geographic location from at least one of a server and user input; (b) obtaining information regarding environmental activities in the geographic location; (c) correlating the biological data and the information regarding the environmental activities within a period of time; and (d) simulating a potential environmental impact of an activity based on the correlation.

### CROSS-REFERENCE TO RELATED APPLICATIONS

This application claims the benefit of U.S. Provisional Application No. 61/970,187 filed Mar. 25, 2014, the contents of which are incorporated herein by reference in their entirety.

### FIELD OF THE DISCLOSURE

The present disclosure, in general, relates to analyzing and presenting environmental data associated with a given geographic coordinate.

### BACKGROUND

The advent of the Internet, the smartphone, the Cloud, community fingerprinting, and metagenomic pyrosequencing offers relatively cheap and easy access to genetic and other biological data. Today, vast biological databases are available to practically every Internet user. However, complementary technologies to facilitate the effective usage of the data are absent. It would be beneficial to have a cost-effective and easy-to-use tool to manage, analyze, and present the environmental data in easy-to-understand formats.

### SUMMARY

The present disclosure provides, in some embodiments, computer executable instructions for use on a digital computing device to retrieve, manage, analyze, and present environmental data. In some embodiments, geographical, epidemiological, meteorological, and biological data is presented in easy-to-understand formats; metadata concerning relationships between the data is provided; and different biological aspects of a given geographic location are assessed. The concepts of this disclosure are applicable to personal, commercial, and scientific applications.

In some embodiments, the computer executable instructions include instructions for a front-end user interface for receiving user inputs and displaying biological profiles, a back-end application for data searching and processing, and an interface to external databases to retrieve relevant data from various databases. In some embodiments, the computer executable instructions include instructions for generating simplified biological scientific data and graphically portraying relevant data associated with a given geographical location.

In one embodiment, a method of managing environmental data associated with a geographic location includes: (a) obtaining geographical data of the geographic location; (b) obtaining meteorological data of the geographic location; (c) obtaining biological data of the geographic location; (d) cross-linking the geographical data, the meteorological data, and the biological data of the geographic location; and (5) presenting the cross-linked data for the geographic location in a graphic format.

In one embodiment, a method of environmental analysis includes (a) acquiring biological data of a geographic location from at least one of a server and user input; (b) obtaining information regarding environmental activities in the geographic location; (c) correlating the biological data and the information regarding the environmental activities within a period of time; and (d) simulating a potential environmental impact of an activity based on the correlation.

In another embodiment, a method of personal environmental analysis includes: (a) obtaining geographical data of the geographic location; (b) obtaining meteorological data of the geographic location; (c) obtaining biological data of the geographic location; (d) obtaining epidemiological data of the geographic location; (e) cross-linking the geographical data, the meteorological data, the epidemiological data, and the biological data of the geographic location; and (f) assessing a personal health impact based on the cross-linking

Other aspects and embodiments of the disclosure are also contemplated. The foregoing summary and the following detailed description are not meant to restrict the disclosure to any particular embodiment but are merely meant to describe some embodiments of the disclosure.

### BRIEF DESCRIPTION OF THE DRAWINGS

FIG. 1 illustrates an example of a system for environmental data analysis;

FIG. 2 illustrates an example of a user interface to an environmental data analysis system; and

FIG. 3 illustrates an example of an architecture for environmental data analysis.

Some or all of the figures are schematic representations by way of example; hence, they do not necessarily depict the actual relative sequence or locations of the blocks shown. The figures are presented for the purpose of illustrating one or more embodiments with the explicit understanding that they will not be used to limit the scope or the meaning of the claims that follow below.

### DETAILED DESCRIPTION

The following examples serve to illustrate the present disclosure. These examples are in no way intended to limit the scope of the disclosure.

In some embodiments, biological scientific data regarding a geographic location can be presented in a unified series of screens. The biological scientific data includes data from public sources, commercial databases, and user measurement results. Relationships between these different data sets, as well as other data, may be presented. Other data may include, for example, Shannon-Weaver diversity index and other indicators of species richness. In some embodiments, other environmental data responsive to specific user requests can also be processed and presented.

In some embodiments, environmental data analysis can be used in assessing biological aspects of a given location for different applications, for example, scientific discovery, personal environmental reconnaissance, and land-use planning

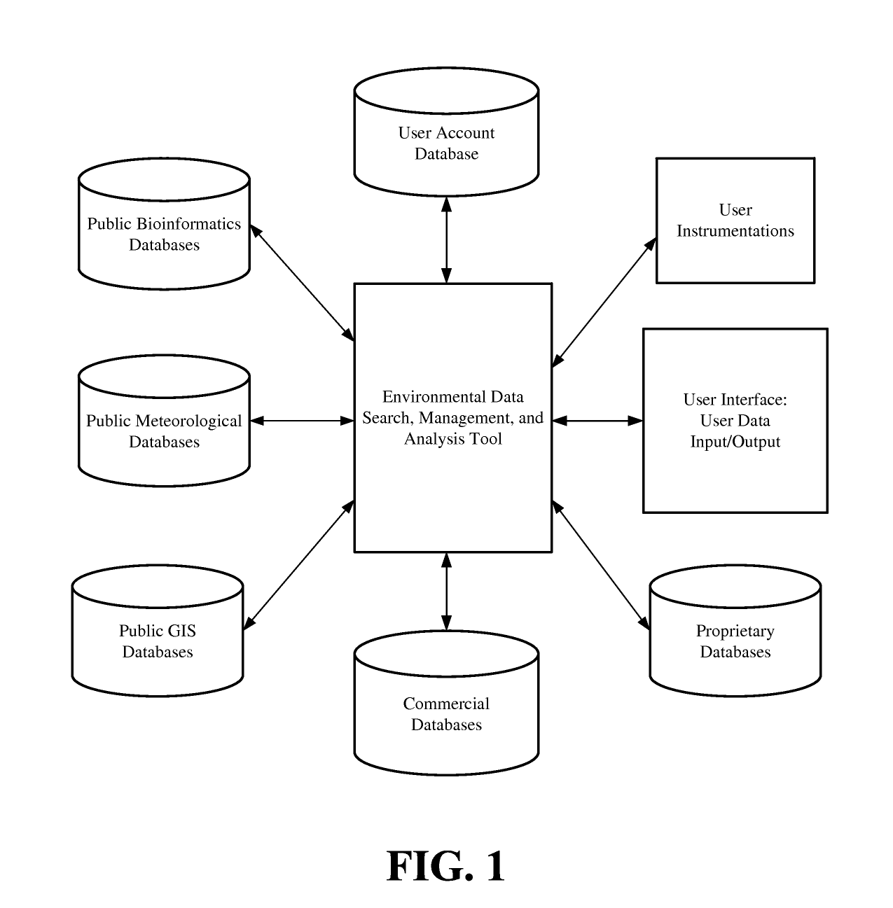

FIG. 1 illustrates an example of a system in which environmental data from public sources, user inputs, or proprietary servers may be retrieved and analyzed.

Meteorological data and geographical data, such as temperature, temperature with chill, hygrometer (humidity), barometer, wind speed, dew point, digital latitude and longitude, and elevation, may be retrieved from many public sources, primarily governmental sources, including National Oceanic and Atmospheric Administration (NOAA), National Climatic Data Center, NOAA Soil Moisture Databases, National Center for Environmental Prediction Databases, U.S. Geological Survey (USGS), LandSat, Central Intelligence Agency (CIA) World Databank, Berkeley Earth Surface Temperature Project (BEST), NASA's World Winds, United Nation (UN) Environment Programme, the Global Forest Cover Change Project, Shutter Radar Topography Mission, and Moderate Resolution Imaging Spectroradiometer (MODIS) Fire Detection. Private commercial databases are also available.

Soil pH and phospholipid-derived fatty acids (PLFA) may be gathered from field laboratory testing at a specific location. Soil pH value may be measured, for example, by litmus paper and, more accurately, with a glass electrode potentiometer or standalone measurement tool.

16s rRNA data concerning specific geographical location is available from multiple sources. For example, publicly available biological and genomic data associated with geographical locations in Alaska and Northern Canada include Quantitative Insights into Microbial Ecology (QIIME, or “chime”), Great Rivers Observatory (GRO) Database associated with the Arctic Great Rivers (PARTNER) project, and the Earth Microbiome project. Bioinformatic tools, such as Greengenes, SILVA, EzTaxon, and the Ribosomal Database Project, can process rRNA data and return phylogenetic trees and other population data concerning microbial communities. Recent Minimum Information about a Marker Gene Sequence (MiMARKS) standardization of protocol for actual data reported to a genomic database improves the ontological consistency and integrity of genomic databases.

Metagenomic databases include the Community Cyberinfrastructure for Advanced Microbial Ecology Research and Analysis (CAMERA), the Metagenomics RAST (MG-RAST), Integrated Microbial Genomes (IMG), QIIME, and other primary and secondary databases. Metagenomic data can also be retrieved from PubMed and National Center for Biotechnology Information (NCBI) by keyword searching.

In some embodiments, data may also be gathered from standalone user measurement instruments. User gathered data can be entered into the system manually or imported electronically through connections such as a USB port or a wireless protocol.

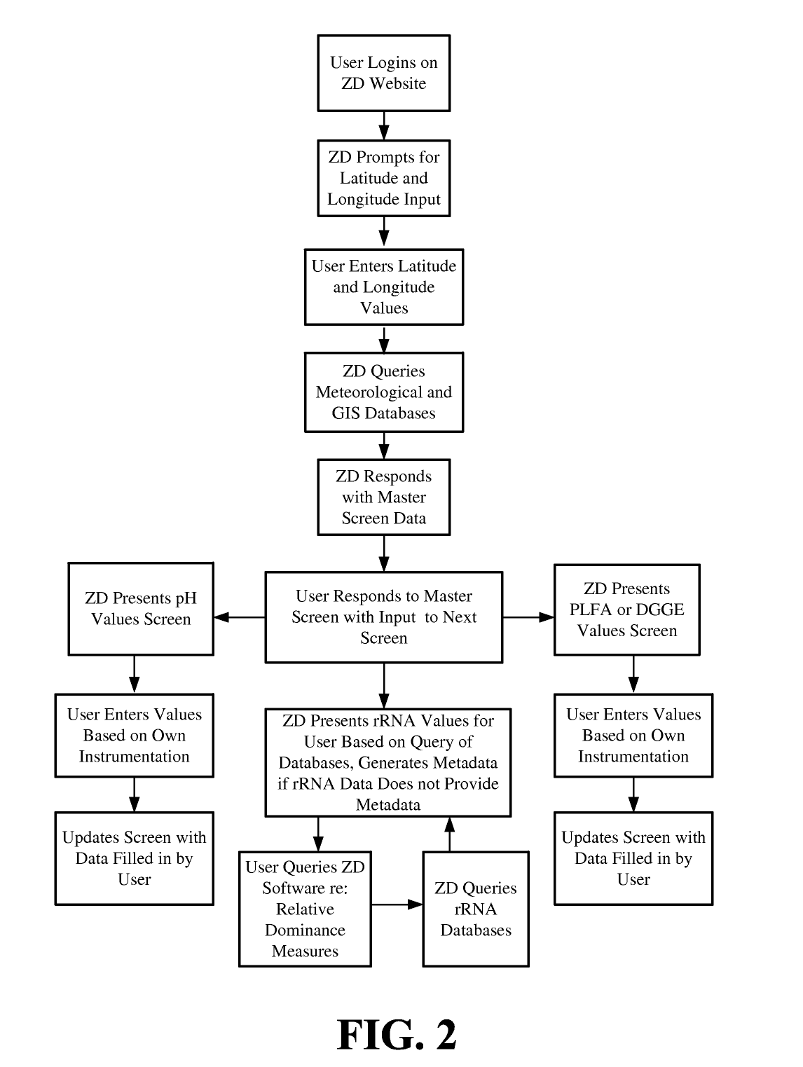

FIG. 2 illustrates an example of a user interface to the environmental data analysis tool, which can receive user input and present simplified biological scientific data about a given geographical location in graphic formats.

Following an optional password-secured login and an optional geographic coordinate entry, an initial screen, or Master Screen, may be displayed, from which users can toggle to other data screens. The geographic location may also be acquired automatically from other applications on a computing device (e.g., a global positioning system (GPS) application or other geo-locator applications), determined from the IP address of the computing device, determined by triangulation, or determined through other location techniques. The Master Screen may present information including temperature, temperature with chill, hygrometer (humidity), barometer, wind speed, dew point, compass rose, digital latitude and longitude, and elevation.

A user can provide an input command, such as by touching or clicking “Next” on the interface display screen, to navigate from the Master Screen to other data screens. Access to each screen may be available from the Master Screen. No specific sequence needs to be followed.

In some embodiments, a display screen may indicate soil pH measures. pH values from acidity to alkalinity may be presented graphically along an X axis, as well as with a number.

In some embodiments, a display screen may present PLFA analysis results. PLFA indicates biomass and microbial community makeup generally through volume and specific types of lipids in a given soil sample. PLFA may be measured by applying chemicals to a dried soil sample, causing water and lipids to separate, and conducting mass spectrometry analysis.

In some embodiments, a display screen may consist of DGGE bands. DGGE analysis essentially shreds (denatures) and separates DNA or RNA samples such that they can be assessed according to the distinct population of eukaryotes or prokaryotes in a given sample.

In some embodiments, a display screen may present 16s rRNA data. This particular gene is universal to prokaryotes. It is highly conserved and therefore is excellent for comparative study between bacterial species. In some embodiments, data concerning 18s rRNA, which functions in a comparable manner for eukaryotes as 16s rRNA for prokaryotes, may be displayed. Staggered chronological readings of the relative diversity of 16s rRNA data over different time intervals at the same geographic spot may be displayed to indicate the resiliency of the microbial community over time.

In some embodiments, a display screen may present local data regarding epidemiological conditions from external databases.

In some embodiments, a display screen may present local data regarding airborne particulate conditions, for example, air quality, from external databases or from a user's observation input.

In some embodiments, a display screen may present the sequenced results of the soil metagenome from rhizosphere, the layer of soil occupied by roots, or in the absence of roots, the shallowest layer of soil.

In some embodiments, a display screen may present metagenomic data from fungal and other eukaryotic surface samples.

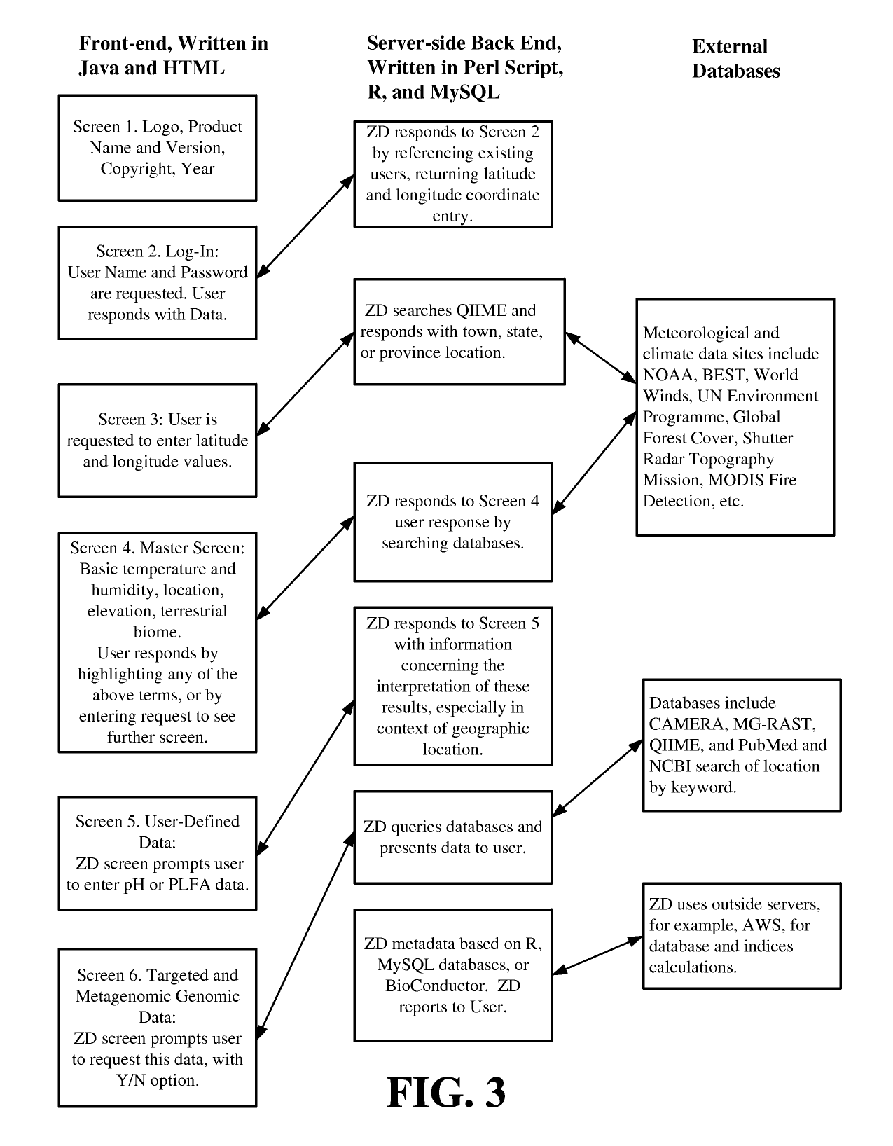

FIG. 3 illustrates an example of an architecture for environmental data analysis, including a front-end user interface, a server-side back end, and an interface with external databases. In some embodiments, the system further includes proprietary databases and provides access to other private commercial databases.

In some embodiments, users can access the system for environmental data analysis on a digital computing device, such as a laptop, an iPhone or other smart-phone or wearable computing device, a desktop, or a tablet, either locally or through a web browser. For geographically remote locations, web access through satellite communication may be preferred.

The front-end user interface takes user inputs and requests, presents simplified biological scientific data, and graphically portrays other relevant data about a given geographical location. The user inputs include login information, geographic location selection, and user measurement data. The biological scientific data associated with a geographic location may be presented graphically in a unified series of screens at a user's request. Each screen can present at least one set of data, such as meteorological data, soil pH values, PLFA data, Denaturing Gradient Gel Electrophoresis (DGGE) bands, 16s rRNA data, soil metagenome, and metagenomic data from fungal and other eukaryotic surface samples. Users can choose which data set to display from a menu. The front-end user interface may be written in programming languages such as Java and HTML.

The interface with external databases communicates with external databases and searches databases for relevant information. The external databases may include public databases, private commercial databases, user databases, and proprietary databases provided with the system.

The server-side back end responds to user inputs and requests, queries public or private databases, and generates relationship data, other metadata, and data responsive to specific user requests. A server can be either a hardware device or a virtual device. A physical ownership of servers is not necessary. Virtual server, such as Amazon Web Services' Elastic Cloud Compute virtual machine, where programming tools available in EC² facilities' CloudBioLinux can be run, may be used. The back end may be written in programming languages such as Perl Script, R, Python, and MySQL.

In some embodiments of the present disclosure, the back end includes a search engine which can query available database information. In addition, the search engine may conduct metadata searches and accumulate information for users and as proprietary information.

In some embodiments, the metadata acquired and generated in the back end include biological diversity indices indicating dominant species and metadata derived from the diversity indices correlated to soil pH and PLFA measures, and to meteorological data and geographic information survey (GIS) data such as that from the CIA World Data Bank II, the Global Lakes and Wetlands Database, NASA's Landsat Imagery data, and the SPOT world vegetation maps.

In some embodiments, metadata derived from the variegated data sources, such as Shannon-Weaver diversity index, and other indicators of species richness, may be generated and presented.

Microbial community in a given microbiome is affected by biotic and abiotic factors, which can be expressed by Y=[f]X, where x is a given alteration such as soil, oil spill, or other human disruptions in proximity; y0 is the baseline microbial community at time t; and y1 is the altered microbial community or microbial community at time t+1.

In some embodiments, relationships between different data sets, for example, 16s rRNA diversity indices, can be calculated. In some embodiments, a user may enter several geographic coordinates at certain distance away from a point of interest. Metadata can then be generated from the 16s rRNA data and other data associated with these geographic coordinates to reveal relationships between changes in prokaryotic life and alterations in locations (longitude and latitude), soil characteristics, gross weather measurements, elevations, and other biotic features.

In some embodiments, metadata regarding relationships between dominant microbial species and volume of microbial activity with environmentally significant events such as logging, drilling, gold mining, nearby construction of roads or buildings, changes in animal life, human usage such as hiking, and forest fires, may be generated. By assessing a multiplicity of biotic factors within even relatively short period of time, the effects of human activities, for example, building, digging, releasing chemicals, spilling oil, bioremediation and fungal bioremediation, and foot traffic, on microbial climax communities, the existence or formation of dominant species, and other facts about bacterial life, can be discovered.

In some embodiments, relationships between exogenous events resulting from human activities and soil metagenomic and surface eukaryotic measures (specifically highly conserved 18s rRNA measures) over time can be closely analyzed, in tandem with 16s rRNA data.

Mathematical models can be built based on discovered relationships to simulate the potential environmental impacts of human activities or events resulting from natural processes of the Earth, for example, floods, droughts, heat waves, blizzards, and earthquakes.

The environmental data management and analysis system disclosed herein can provide a highly integrated tool to researchers in scientific analysis and discovery. By managing user collected data, retrieving relevant data from different databases, analyzing aggregated data to extract relationships between different datasets, modeling and simulating environmental impact of different events, and presenting the results in easy-to-understand formats, the system could make scientific research more efficient, more thorough, and less expensive.

Since the disclosed system is highly integrated and easy to use, and the results are easy to understand, an individual can use the system for purposes other than scientific research. For example, from the environmental data and relationships between these data, individual users interested in the biological life in their immediate homes, workplaces, and other areas, and users concerned with quantitative measures of personal health (or Quantified Local Environment) can conduct personal environmental assessment and obtain health and safety guidance.

Other applications of the metadata include but are not limited to environmental analysis for land-use development, for bioprospecting, for bio-remediation; and for pathogen and pollutant detection.

In some embodiments, the metadata can provide useful expository and analytical inputs in making commercial or personal decisions. Comprehensive biological and human factors data may be useful in regional land-use planning for the industries and for stakeholders of the region, as well as for emerging industries such as wood biomass agriculture, cold-climate agriculture, and the increasing demands of bioremediation. For example, comprehensive mapping and analysis of biological data and human factors may provide valuable prediction on the exploitation of the increasingly politically strategic and economically useful land of Alaska and Northwestern Canada.

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, flash drives and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A method of managing environmental data associated with a geographic location, comprising:
obtaining geographical data of the geographic location;
obtaining meteorological data of the geographic location;
obtaining biological data of the geographic location;
cross-linking the geographical data, the meteorological data, and the biological data of the geographic location; and
presenting the cross-linked data for the geographic location in a graphic format.

2. The method claim 1, wherein obtaining geographical data of the geographic location includes obtaining latitude and longitude values from a user interface of a computing device, and using the latitude and longitude to determine a locator identifying a town, state or other province.

3. The method claim 2, wherein obtaining meteorological data of the geographic location includes using the locator to identify relevant information in a database.

4. The method claim 1, wherein obtaining geographical data of the geographic location includes obtaining positional information from a geo-positioning locator of a computing device and using the positional information to determine a locator identifying a town, state or other province.

5. The method claim 4, wherein obtaining meteorological data of the geographic location includes using the locator to identify relevant information in a database.

6. The method claim 1, wherein obtaining meteorological data of the geographic location includes sending a request to retrieve information from a public database of climate information, and receiving meteorological information related to the geographic location from the public database.

7. The method claim 1, wherein obtaining biological data of the geographic location includes sending a request to retrieve information from a public database of biological information, and receiving biological data related to the geographic location from the public database.

8. The method claim 1, wherein obtaining biological data of the geographic location includes receiving biological data related to a soil sample from a computing device.

9. The method claim 1, wherein cross-linking the geographical data, the meteorological data, and the biological data of the geographic location includes cross-correlating the data, and presenting the cross-linked data for the geographic location in a graphic format includes presenting the cross-correlation results.

10. A method of environmental analysis, comprising:
acquiring biological data of a geographic location from at least one of a server and user input;
obtaining information regarding environmental activities in the geographic location;
correlating the biological data and the information regarding the environmental activities within a period of time; and
simulating a potential environmental impact of an activity based on the correlation.

11. A method of personal environmental analysis, comprising:
obtaining geographical data of the geographic location;
obtaining meteorological data of the geographic location;
obtaining biological data of the geographic location;
obtaining epidemiological data of the geographic location;
cross-linking the geographical data, the meteorological data, the epidemiological data, and the biological data of the geographic location; and
assessing a personal health impact based on the cross-linking.
